(19) United States
(12) Patent Application Publication
(10) Pub. No.: US 2026/0305653 A1
(43) Pub. Date: Oct. 8, 2026

(54) IMPROVED PROCESS FOR PRODUCING VEGETABLE PROTEIN CONCENTRATES

(71) Applicant: Desmet Belgium, MACHELEN (BE)

(72) Inventors: David DE SCHAETZEN, SOMBREFFE (BE); Wim DE GREYT, SINAAI (BE); Marc KELLENS, MECHELEN-MUIZEN (BE)

(73) Assignee: Desmet Belgium, MACHELEN (BE)

(21) Appl. No.: 19/482,842

(22) PCT Filed: May 12, 2023
(86) PCT No.: PCT/EP2023/062783

§ 371 Date: Nov. 10, 2025

(51) Int. Cl. A23J 3/26; A23J 1/14; A23J 3/16; A23P 10/25

(52) U.S. Cl. CPC A23J 3/26; A23J 1/144; A23J 3/16; A23P 10/25

(57) ABSTRACT

The invention relates to a process for producing plant-based protein concentrates from desolventized meal resulting from hexane extraction of oleaginous vegetable material and, preferably, from a high-quality desolventized and defatted meal known as “white-flakes”. In particular, the invention relates to a substantial improvement allowing the valorisation of the fines and dust contained in white-flakes by their agglomeration in specific extractable and undegraded agglomerates of food-grades quality. This improvement allows a substantial yield increase of the extraction process without jeopardising the quality of the final plant-based protein concentrate.

### FIELD OF THE INVENTION

The present invention relates to a process for producing plant-based protein concentrates from the desolventized meal resulting from the hexane extraction of oleaginous vegetable material and, preferably, from a high-quality desolventized and defatted meal known as “white-flakes”. In particular, the invention relates to a substantial improvement allowing the valorisation of the fines and dust contained in white-flakes by their agglomeration in specific extractable and undegraded agglomerates of food-grades quality.

### BACKGROUND OF THE INVENTION

Plant-based feed and food protein products such as soy protein and rapeseed protein concentrates are increasingly in demand in order to replace and/or complement proteins from animal origin. Such steady increasing demand is motivated by environmental, ethical, and economic reasons. Furthermore, replacing animal-based protein products by plant-based protein products in the human diet is recognised as healthy by a large fraction of the public which further fosters the high demand of plant-based protein products.

Currently, the most prevalent plant-based protein products are derived from soybean and in particular from soy protein concentrate. However, plant-based products derived from seeds (such as rapeseed, sunflower) or legumes (such as peas, lentils) have been the object of promising evaluations and niche commercialisations as well.

Soy protein concentrates contain preferably at least about 60% and even more preferably at least 65% of proteins (weight/weight on a dry basis) and are typically produced from a starting vegetable material already enriched in protein: a desolventized meal resulting from solvent extraction of dehulled soybean. The evaporated solvent is nearly systematically commercial hexane which is a blend of various hexane isomers including a substantial proportion of n-hexane. In the industry it is simply referred to “hexane” which is the term that will be used in this description.

Commonly, the hexane is evaporated in a Desolventizer-Toaster-Dryer-Cooler (DTDC) which results in a toasted meal having a strong beany taste and odour not appealing to human. Furthermore, the proteins are degraded because, in a DTDC, they have been exposed simultaneously to high temperature and moisture during a rather long time. However, this meal resulting from a DTDC is suitable for feed applications either directly or as starting material leading to feed-grade protein concentrates especially useful for ruminants.

For food applications and some niche feed applications (aquaculture for example), a meal known as “white-flakes” is used as starting material. White-flakes result from the rapid desolventization of the solvent-wet residue obtained after the solvent extraction of dehulled soybean flakes. The rapid desolventization (known in the field as flash-loop desolventization) of the solvent-wet meal minimizes the degradation of its proteins and furthermore minimize greatly the apparition of unpleasant taste and odour and also results in a lighter colour justifying the name of this particular meal (‘white’-flakes).

Many processes for the production of protein concentrates have been disclosed over the past years. However, at present, commercially, the most widespread process involves the counter-current extraction of the starting material (a desolventized meal) with an aqueous ethanol solution containing about 60 to 70% of ethanol (weight/weight). Such aqueous ethanol solution has the ability to solubilise and specifically extract a substantial fraction of the sugars present in the meal without extracting any significant amount of the proteins. After the extraction of the sugars, the solvent wet residue is dried to remove substantially all ethanol and excessive water to yield the final protein concentrate containing usually more than about 60% of protein (on a dry basis).

However, in this process involving aqueous ethanol as extraction solvent, even if the proteins are essentially not extracted, they will nonetheless absorb a substantial amount of water, swell, and form a compact and sticky matter. Consequently, the percolation of the aqueous ethanol and its drainage are poor in comparison to the percolation and drainage observed when the oil is extracted with hexane. As a matter of fact, in order to maintain acceptable solvent percolation and drainage, the starting meal must be sieved to remove dusts and fines, especially if the starting material is white-flakes. Indeed, it is those fines and dust that have the most detrimental effect on solvent percolation and drainage. However, the sieving removes a substantial fraction of the starting material. As a matter of fact, white-flakes contain usually about 20% to about 50% of fines/dust and small particles, the exact amount depending on many factors (manufacture, transportation, storage, handling methods, etc.). Therefore, the sieving and fines removal represent a dramatic and costly material loss since the fines are typically blended in a meal of lower value. Furthermore, handling and storage of fines are difficult and can be hazardous. Altogether, this situation is a serious issue in the industry and further increases the cost of producing high quality food-grade soybean protein concentrates.

Thus, the present process is particularly useful for soy protein concentrates prepared from white flakes obtained with an equipment known in the field as “flash loop”. The flash loop does not work under vacuum but makes use of superheated hexane of 130-140° C. used as stripping agent which allows most of the hexane to flash out in a few seconds (typically from about 30% down to less than about 5% hexane) and therefore the protein quality is not affected. As the flashed meal which still contains a substantial amount of hexane (typically about 2% to about 5%), the meal is then transferred to a vacuum-desolventizer where the rest of the hexane is evaporated at typically 70-80° C. by injecting sparge steam through the meal. The final desolventized meal (white-flakes) contains less than 500 ppm of solvent and is very dry containing typically about 5% if moisture. However, the amount of steam used in the vacuum-desolventizer is considerably smaller than the amount used in a conventional DTDC operating at essentially atmospheric pressure. The residence time is also shorter since it operates under vacuum and the quantity of hexane to be evaporated is reduced. Those circumstances protect the quality of the proteins and therefore the resulting fully desolventized white-flakes still possess high protein solubility.

Thus, the proteins remain of good quality i.e., soluble, witnessing the fact that they are not denatured by excessive and long heating in presence of large quantity of water. Indeed, proteins contained in white-flakes remain soluble and have thus a high PDI (Protein Dispersibility Index) and high NSI (Nitrogen Solubility Index). Consequently, white-flakes are the starting material of choice for food grade soy protein concentrates and for high-end feed grade soy protein concentrates intended for mono-gastric animals. However, white-flakes are particularly fluffy and brittle material containing a large proportion of dust and fines. Furthermore, each handling of this material generates additional dust and fines.

When the hexane is evaporated with a standard DTDC, the solvent wet meal is contacted with significant amount of contact steam which condenses at least partially in the meal. Thus, the meal is exposed to heat during a longer time in presence of water which results in the Maillard reaction between proteins and sugars making the proteins less soluble. In the field this phenomenon is called “toasting”. However, the resulting toasted-meal is less fluffy and contains less fines. The fact that the sugars are partially chemically bonded to the proteins probably results in a less brittle material. A “toasted” meal is usually appealing to ruminants which are also able to fully digest such material unlike mono-gastric mammals. On the contrary, this “toasted” taste and odour is not appealing to humans and therefore toasted meal is seldomly used as starting material for the production of protein concentrate for food application. Furthermore, since the sugars tend to be chemically bonded to the protein in toasted meal, lower extractability of said sugars by aqueous ethanol has been observed.

Consequently, it must be understood that any process aiming at the valorisation of fines as starting material for production of food-grade protein concentrates should also preserve the initial quality of the proteins contained in the white flakes i.e., their solubility (assessed by PDI or NSI) and their organoleptic properties (i.e., the taste, odour and colour which can be assessed for example by a panel of trained technicians).

Therefore, a process attempting to valorise those dust and fines sieved from white-flakes has been disclosed by U.S. Pat. No. 5,097,017A which describes a method for making soy protein concentrate wherein defatted flakes are subjected to ethanol extraction, including a step of agglomerating flake fines material in a die-less auger prior to said extraction.

However, despite the merit of U.S. Pat. No. 5,097,017A, in a die-less auger (such as an extruder of an expander), the agglomeration of the fines can only happen if those ones are mechanically mixed under high shear-stress and simultaneously heated at sufficient temperature in the presence of water in order to compensate the absence of the die which would finally shape and agglomerate the processed matter. This processing, under severe mechanical shear-stress at relatively high temperature and in the presence of substantial amount of water is likely to cause simultaneously the Maillard reaction resulting in toasting, discoloration and the formation of a beany taste and odour. This is due to the fact that, in the absence of a die finally shaping the processed material at the exit of the processing device, the only possibility to agglomerate the fines is imposing enough mechanical shear combined to high temperature and enough water to promote a chemical bonding of the loose particles. Those conditions will degrade the organoleptic properties of the produced agglomerates. Indeed, it is reported that the agglomerates produced according to U.S. Pat. No. 5,097,017A are darker and have a beany odour. Therefore, the fines' agglomerates produced by this known process can be used successfully as starting material for the production of protein concentrates for feed applications but cannot be used as starting material for the production of protein concentrates for food applications which still represents a substantial financial loss. Furthermore, since the darkening and the development of a beany odour of the fines' agglomerates witness the degradation of the proteins and their bonding with the sugars, their extractability may be reduced as well which leads to lower extraction yield thus to a protein concentrate having a lower protein content.

Therefore, despite the merits of the prior art there remains a need for a process allowing the agglomeration of fines and dust of white-flakes meal into agglomerates without the generation of toasting, discoloration, emergence of a beany taste and odour, and reduced extractability of sugars by aqueous ethanol.

### OBJECT AND ADVANTAGES OF THE INVENTION

It is an object of the present invention to provide a process allowing the agglomeration of fines of white-flakes meal into fines' agglomerates with less generation of toasting, discoloration, emergence of beany taste and odour compared to the existing processes. In other words, when compared to existing technologies, the proposed process delivers fines' agglomerates which preserve much more of the quality of the proteins contained in the fines that were sieved from the white-flakes. Additional advantages, such as good extractability of the agglomerates by aqueous ethanol, will become apparent from the present description.

### SUMMARY OF THE INVENTION

The present description will focus on soybean protein concentrates even if it is understood that the production of protein concentrates based on other plant materials could also benefits from the process according to the present invention.

It has been surprisingly observed that the above object can be attained with a process for agglomerating as defined in the appended claims. Especially, the objective can be attained by a process for agglomerating the fines obtained from sieving of desolventized defatted meal comprising the steps of a) moisturizing the fines to produce moisturized fines, b) introducing the moisturized fines into a material processing device to produce fines' agglomerates, wherein the material processing device is equipped with a restriction at its exit and wherein the temperature of the processed fines does not exceed 80° C.

It has been further observed that, surprisingly, the object of the invention can be achieved with the above described process for the production of fines' agglomerates wherein the desolventized defatted meal is white-flakes.

It has been further observed that, surprisingly, the object of the invention can be achieved with the above described process for the production of fines' agglomerates wherein the moisturized fines contain 10% w/w to 20% w/w of water.

It has been further observed that, surprisingly, the object of the invention can be achieved with the above described process for the production of fines' agglomerates wherein the material processing device is selected from a group comprising extruders, expanders and pelletizers.

It has been further observed that, surprisingly, the object of the invention can be achieved with the above described process for the production of fines' agglomerates wherein the restriction at the exit of the processing device is a die or a cone.

It has been further observed that, surprisingly, the object of the invention can be achieved with the above described process for the production of fines' agglomerates wherein the restriction at the exit of the processing device is a die or a cone and said die or cone is further equipped with a knife.

It has been further observed that, surprisingly, the object of the invention can be achieved with the above described process for the production of fines' agglomerates wherein said fines' agglomerates have a diameter comprised between 1 mm and 10 mm.

It has been further observed that, surprisingly, the object of the invention can be achieved with the above described process for the production of fines' agglomerates wherein the fines' agglomerates have a length comprised between 2 mm and 20 mm.

It has been further observed that, surprisingly, the object of the invention can be achieved with the above described process for the production of fines' agglomerates wherein said fines' agglomerates are further crushed.

It has been further observed that, surprisingly, the object of the invention can be achieved with the above described process for the production of fines' agglomerates wherein said fines' agglomerates are bland in odour and taste.

It has been further observed that, surprisingly, the object of the invention can be achieved with the above described process for the production of fines' agglomerates wherein said fines' agglomerates remain light in colour.

It has been further observed that, surprisingly, the object of the invention can be achieved with the above described process for the production of fines' agglomerates wherein said fines' agglomerates has PDI greater than 38.

### DETAILED DESCRIPTION OF THE INVENTION

Most surprisingly, it has been observed that extractable and food-grade fines' agglomerates can be obtained by processing the fines with processing devices equipped with dies or other flow restrictive means such as expanders' cones for example. This observation is indeed highly surprising in regard to known prior art disclosing opposite teachings. However, we have observed that precise processing conditions are needed in order to produce extractable and food-grade fines' agglomerates such as the temperature and the compaction which must remain moderate. Furthermore, proper conditioning of the fines with minimal amount of water prior said processing is also necessary. Those findings have been observed from a large set of experiments realised with three different material processing devices (extruder, expander and pelletizer) which are disclosed in full detail in the example sections.

The results and observations fully disclosed in the example section permit to precisely define the essential as well as optional features of the process according to the present invention allowing to produce extractable and food-grade fines' agglomerates. The properties of the fines' agglomerates produced by the process according to the present invention are also detailed. Those features and properties are discussed below and will permit to the skilled artisan to fully understand the process according to the present invention.

Processing devices. A variety of material processing pieces of equipment such as extruders, expanders, and pelletizers will be suitable for the process according to the present invention as long as the temperature of the processed fines can be controlled adequately and maintained below 80° C. and even below 70° C. Furthermore, the material processing equipment must be equipped with a restriction section at their exit such as a die or other restriction device such as a cone in the case of expanders. The necessity of this restriction section is highly surprising since prior art disclosed evidences to the contrary.

Restriction section at the exit of the processing devices. All processing equipment must be equipped with a restriction section such as for example a die (or optionally a cone in the case of expanders), of sufficient length in order to shape the fines into pellets. The geometry of the restriction section will preferably impose a moderate back-pressure to the processed fines in order to avoid excessive shear-generated heating. When a pelletizer is selected as the processing device, good results have been obtained with a die length of 8 mm having openings of 4 mm diameter. When extruder is selected as the processing device, good results have been obtained with a die length of 8 mm having openings of 4 mm diameter. When expander is selected as processing device, good results have been obtained with a die length and diameter of 10 mm to 15 mm. The die can advantageously be equipped with a knife. This will permit to limit the length of the agglomerated fines to the desired dimension. It must be noted that such requirement is in sharp contrast with the established prior art. As a matter of fact, attempts to produce fines' agglomerates have been realized in the absences of a die or other restrictive means while the processing temperature was maintained below 80° C. and the amount of water in the starting fines was below 20% with no steam injection introduced in the processing equipment. However, those attempts failed to deliver agglomerates since the fines remained essentially lose and not properly compacted into discrete entities. This observation is not expected in regard to prior art and not fully understood. Without willing to be bound by any theoretical consideration, it can be speculated that in order to limit the thermo-mechanical degradation of the fines, the process according to the present invention purposely limits the processing temperature, the mechanical shear-stress, the moisture level and the compaction of the fines, and, consequently, those conditions are not sufficient per se to produce sufficiently compacted fines agglomerates when the processing equipment is not equipped with a die or any other alternative restriction devices placed at the exit of said processing equipment.

Fines' agglomerates dimension. Preferably, the fines are processed into agglomerates having a dimension of a few mm in diameter and length (typically from about 1 mm up to about 10 mm and preferably from about 2 mm to about 8 mm). Larger agglomerates may require to be further cracked which add a processing step and will create new fines which may reduce the percolation during the extraction, even if surprisingly, acceptable percolation was still observed even for the cracked fines' agglomerates. Our results disclose that very small agglomerates of about 2 mm diameter can be produced by the process according to the present invention and such agglomerates of about 2 mm diameter do not need to be cracked before being extracted by aqueous ethanol. The length of the agglomerates can be tailored by the speed of a knife which typically is fitted to the die or to the alternative restriction device. Typically, a length from about 2 mm up to about 20 mm is preferable. Good results have been observed for fines' agglomerates with a length of about 4 mm, but the present invention is not limited to this precise length. As a matter of fact, another advantage of the process according to the present invention is the possibility to tailor the dimension of the fines' agglomerate very easily by selecting the appropriate die and by adjusting the knife speed. Therefore, the dimensions of the agglomerates produced by the process according to the present invention are well defined, uniform and fully tuneable by the selection of the dies (or alternative restriction mean) having the appropriate diameter openings and by selecting the adequate knife speed. Such possibilities are not possible if the fines processing device is not equipped with a die as taught by prior art. Indeed, in that case, both the diameter and the length of the fines' agglomerates are not tuneable and broadly diverse in shape and in dimension which lack of control is not conclusive of well reproducible and efficient processes.

Temperature. It is essential to keep the temperature of the processed fines below 80° C. and even preferably below 70° C. in order to avoid or at least substantially limit the degradation and denaturation of the fines' proteins as well as to avoid or at least substantially limit the generation of darkening and beany odour and taste. As a matter of fact, the process according to the present invention even allows the production of fines' agglomerates at a processing temperature of about 50° C. which will limit substantially protein degradation and organoleptic alteration. It is believed that the presence of the die or alternative restriction mean at the exit of the material processing device permits to sufficiently agglomerates the fines without necessitating high temperature and/or intense mechanical mixing during the fines' processing such as disclosed in the prior art. Thus, the process according to the present invention is advantageous for the quality of the fines' agglomerates and preserve significantly the initial quality of the white flakes' fines. Contrary to results achieved in existing processes, the fines' agglomerates produced with the process according to the present invention remain valuable starting material for food-grade protein concentrates and especially soybean protein concentrates.

It must be stressed that the temperature of the fines during their processing in fines' agglomerates may depend on active heating means of for example the barrel of the processing devices that can be heated with heating collar for example or other mean known in the art. However, the temperature increase during the processing is often generated by the mechanical friction of the processed material. Therefore, attention is needed to not impose excessive mechanical friction when processing the fines. In this regard, in the process according to the present invention, the necessity of a die is advantageous since the shaping and compaction of the fines into agglomerates take place essentially in the die and therefore intense mechanical friction imposed by the screw of the processing device is not needed to achieve such shaping and compaction.

Fines' agglomerates compaction. Care should be taken to avoid excessive fine's agglomerates compaction since porous and highly extractable fine's agglomerates are preferred. It has been shown that the process according to the present invention allows the production of such porous and highly extractable fines' agglomerates despite the use of a die. This is highly surprising since it is obvious that a die will impose a substantial compaction to the fine's agglomerates and such compaction will have an adverse effect on the porosity. However, the use of a die or alternative restriction mean also permits to shape the fines into agglomerates at a much lower temperatures than the ones disclosed by prior art process for which dies are not used. It is thus surprisingly observed that this low processing temperature compensates more than expected the adverse effect of the die (or other restriction mean). This observation is totally surprising and could not be anticipated by studying the teachings of the prior art. For example, it has been shown that fine's agglomerates having a diameter of about 2 mm remains perfectly extractable and leads, after extraction, to protein concentrate with sufficient protein concentration and sufficient yield. Furthermore, their organoleptic properties make them acceptable for food-grade application as well.

Attempts to produce fines' agglomerates have been realized with a processing device not equipped with die. However, those attempts failed to deliver sufficiently compacted agglomerates since the fines remained essentially lose and not properly compacted into discrete entities. This observation is not expected in regard to prior art and not fully understood. Without willing to be bound by any theoretical consideration, it can be speculated that in order to limit the thermo-mechanical degradation of the fines, the process according to the present invention purposely limits the processing temperature and the compaction of the fines in order to limit their degradation; unfortunately, those conditions are not sufficient to produce sufficiently compacted fines agglomerates if the fines' agglomerates are produced with a processing device not equipped with a die.

Fines' moisture concentration. It has been observed that adding water to the fines facilitates greatly its feeding to the material processing equipment (such as for example an extruder, an expander, or a pelletizer). Indeed, fines is an extremely fluffy and pulverulent material difficult to handle and challenging to feed to a material processing equipment. Adding water to the fines results into a more paste-like material easier to handle. Preferably, water is added under a liquid form at room temperature. Optionally the water can be cooled below room temperature to further cool the processed fines. Optionally water can be added under the form of steam, particularly if the fines are very cold, for example in winter in cold-climate countries with fines stored in external silos. Furthermore, the presence of water during the processing will also enhance the agglomeration of the fines. Preferably the total moisture content of the processed fines ranges typically from about 10% to about 20% and should be, as a rule, maintained to a minimum value still effective for proper feeding and/or agglomeration of the fines. Therefore, substantial amount of water must be added to the fines before processing since such material contains typically about 5% of moisture at the exit of the final vacuum-desolventizer (which is placed in-line after the flash-loop).

Organoleptic properties of the fines' agglomerates. The process according to the present invention is able to produce fines agglomerates of satisfactory organoleptic properties for food applications, i.e., bland in odour and taste and sufficiently light in colour even in the case of soybean-based fines' agglomerates. This is particularly remarkable since soybeans are known to be prone to develop beany odours and tastes. Thus, the process according to the present invention is able to produce agglomerates of soybeans' fines that do not present a beany odour and taste. Such beany odour and taste are usually appealing for animals but not for humans and further such beany odour and taste witnesses the poor digestibility and availability of the proteins for mono-gastric mammals. Those organoleptic properties and colour could be quantified by several method including analytical equipment. However, a panel or trained technicians is also an established and acceptable method and such panel has been used in the experiments part. The results delivered by such panel are reproducible and based on the following references: the native white-flakes possess the maximal whiteness and the best organoleptic properties. Toasted-meal, i.e., a meal delivered by a standard DTDC, will be considered dark and having the worse organoleptic properties (beany taste and odour).

Extractability of the fines' agglomerates. The process according to the present invention is able to produce fines' agglomerates having satisfactory extractability of their sugars by an aqueous ethanol solution. Percolation of the aqueous ethanol solution through the fines' agglomerate is satisfactory and allows to significantly increase the production yield of food-grade protein concentrates produced from white flakes since the fines sieved are not discarded but valorised as premium starting material for the production of food-grade protein concentrates. The process according to the present invention is able to produce fines' agglomerates having much higher percolation compared to the initial fines or compared to the non-sieved white-flakes and hence allows a much more efficient removal of soluble sugars which in turn allows to produce SPC with higher protein content.

Thus, the process according to the present invention is able to produce fines' agglomerates having controlled dimensions and having improved percolation, improved sugar extractability combined to satisfactory organoleptic properties. Those fines' agglomerates can thus be used as starting material for the production of protein concentrates for food applications. This is a major improvement over known processes and practices. Furthermore, it must be noted that even soybean-based fines' agglomerates produced according to the instant process still exhibit good organoleptic properties which is remarkable since it is known that such material has a marked tendency to develop beany odours and taste. Those conclusions will be demonstrated with the following examples.

### EXAMPLES

Several experiments have been conducted to assess the qualities and the key performance parameters of the extraction process leading to SPC (Soybean Protein Concentrates) as well as their key quality characteristics obtained from various fines' agglomerates (optionally cracked) made from the fines collected during the sieving of white-flakes. Those fines' agglomerates were obtained with different pieces of material processing equipment i.e., extruder, pelletizer (also called pellet-mill in the industry) and expander and in variable experiment conditions. The SPC characteristics derived from some of the produced fines' agglomerates as well as their extraction behaviour have been assessed.

The key performance parameters of the sugars extraction process leading to SPC are the solvent percolation, the sugar extractability (which influence the protein content of the SPC) and the yield. The key quality characteristics of the obtained SPC are the protein content and quality (PDI), the organoleptic properties and their colour. The organoleptic properties and the colour have been assessed by a panel of trained technicians.

### Starting Material Origin, Preparation, and Characteristics

Non-sieved soybean white-flakes material was collected from a commercial flash loop desolventizer/vacuum desolventizer of a major soybean protein concentrate (SPC) producer. Typically, white-flakes meal is a porous, brittle, white and fluffy material with a bland odour and taste and contains a lot of fines and dust.

The non-sieved soybean white-flakes has been sieved over a 1 mm screen and resulted in a fines fraction amounting to about 25% (w/w) and a sieved white-flakes fraction amounting to about 75% (w/w). The sieving has been realized with an industrial device as presently used in commercial facilities. Therefore, the fines fraction used in those examples is fully representative of the actual fines material the industry has to deal with. In industrial practice, only the sieved white-flakes fraction is extracted counter-currently with aqueous ethanol to produce food-grade protein concentrate, the fines fraction being usually mixed to other meal(s) sold for feed applications having less value. Therefore, the current practice corresponds to a substantial material and financial loss as well as logistical and handling constrains generating additional expenses. However, the fines composition is essentially identical to the one of the sieved white-flakes. As a matter of fact, the fines usually contain about 1% more protein (on a dry basis). Furthermore, fines are also white and bland in taste and odour. Therefore, their loss is even more so damageable since, on a composition perspective, fines appear to be a totally suitable and advantageous starting material to produce SPC.

The fines fractions have been processed to produce agglomerates with various material processing devices in various experimental conditions. The various processing pieces of equipment were pilot-scaled machines manufactured by Kahl (Germany) with reference 14-175 (Pelletizer), reference OER 8 (Expander), reference OEE 8 (Extruder). Dies with various opening diameters have been used (the various diameters are reported in tables 1, 2 and 3). Prior to the processing into agglomerates, water was added to the fines with an MTI Turbo-mixer (Germany). Some fines' granulates have been cracked one or two times with a Neuhaus-Neotec roller-mill (Germany) reference LWM 100-1. Key setting parameters of those various pieces of equipment are collected in tables 1, 2, 3 and 4. Furthermore the granulometry of some selected samples are presented in table 5.

The resulting sieved flakes fraction was used as feedstock for two reference counter-current sugar extraction trials with aqueous ethanol in order to establish the reference characteristics of the protein concentrate obtained from the actual feedstock currently used in the industry. The results are reported in Table 6 for comparison purposes.

TABLE 1
Extruder: settings used to produce the fines agglomerates

| S | A | B | C | D | E | F | G | H | I | J | K | L | M | N |
|---|---|---|---|---|---|---|---|---|---|---|---|---|---|---|
| 1 | Extruder | Yes | 17 | 1 | 50 | 1:2.0 | 102 | 75 | 96-100 | 20 | 96 | 18 | 9.2 | No |
| 2 | Extruder | Yes | 6 | 1 | 50 | 1:2.0 | 96 | 75 | 94-96 | 20 | 98 | 18 | 8.3 | No |
| 12 | Extruder | No | 2 | 1 | 50 | 1:2.0 | 115 | 75 | 98-102 | 20 | 76 | 18 | 11.6 | No |

S: Sample number; A: Processing Equipment type; B: Steam injection (Yes/No); C: Diameter Die openings (mm); D: Screw number; E: Screw Frequency (Hz); F: Screw Compression ratio; G: Hydraulic Pressure (bar); H: Through-put (Kg/hr); I: Extruder Temperature (° C.); J: Temperature Material Inlet (° C.); K: Temperature Material Outlet (° C.); L: Water Content Material Inlet (%); M: Water Content Material Outlet (%); N: Further Cracking (Yes/No).

TABLE 2
Expander: settings used to produce the fines agglomerates

| S | A | B | C | D | E | F | G | H | I | J | K | L | M | N |
|---|---|---|---|---|---|---|---|---|---|---|---|---|---|---|
| 3 | Expander | Yes | 17 | 1 | 50 | 1:2.0 | — | 75 | 96-100 | 20 | 96 | 18 | 9.2 | No |
| 11 | Expander | No | 11 | 1 | 50 | 1:2.0 | — | 151 | 95 | 20 | 70 | 18 | 8.3 | No |
| 14 | Expander | No | 11 | 1 | 50 | 1:2.0 | — | 151 | 95 | 20 | 70 | 18 | 8.3 | Yes |
| 15 | Expander | No | 11 | 1 | 50 | 1:2.0 | — | 140 | 97 | 20 | 78 | 19.2 | 8.5 | No |
| 16 | Expander | No | 11 | 1 | 50 | 1:2.0 | — | 140 | 97 | 20 | 78 | 19.2 | 9.1 | Yes |
| 17 | Expander | No | 11 | 1 | 50 | 1:2.0 | — | 140 | 97 | 20 | 78 | 19.2 | 8.5 | Yes |

S: Sample number; A: Processing Equipment type; B: Steam injection (Yes/No); C: Diameter Die openings (mm); D: Screw number; E: Screw Frequency (Hz); F: Screw Compression ratio; G: Hydraulic Pressure (bar); H: Through-put (Kg/hr); I: Extruder Temperature (° C.); J: Temperature Material Inlet (° C.); K: Temperature Material Outlet (° C.); L: Water Content Material Inlet (%); M: Water Content Material Outlet (%); N: Further Cracking (Yes/No).

TABLE 3
Pelletizer: settings used to produce the fines agglomerates

| S | A | B | C | D | E | F | G | H | I | J | K | L | N |
|---|---|---|---|---|---|---|---|---|---|---|---|---|---|
| 4 | Pelletizer | No | 3 | 2 | 112 | 0.73 | 6.0 | 1:3.0 | 20 | 76 | 13.1 | 7.5 | no |
| 5 | Pelletizer | No | 3 | 2 | 112 | 0.73 | 6.0 | 1:3.0 | 20 | 71 | 18.5 | 9.6 | no |
| 6 | Pelletizer | No | 4 | 2 | 112 | 0.73 | 6.5 | 1:2.0 | 20 | 52 | 18 | 10.6 | no |
| 7 | Pelletizer | No | 4 | 2 | 112 | 0.73 | 6.5 | 1:2.0 | 20 | 52 | 18 | 10.6 | yes |
| 8 | Pelletizer | No | 4 | 2 | 112 | 0.73 | 6.5 | 1:2.0 | 20 | 52 | 18 | 10.6 | yes |
| 9 | Pelletizer | No | 6 | 2 | 112 | 0.73 | 9.0 | 1:1.0 | 20 | 46 | 18.5 | 12.5 | no |
| 10 | Pelletizer | No | 6 | 2 | 112 | 0.73 | 9.0 | 1:2.0 | 20 | 47 | 18.5 | 11.7 | no |
| 13 | Pelletizer | No | 6 | 2 | 112 | 0.73 | 9.0 | 1:2.0 | 20 | 47 | 18.0 | 11.7 | yes |
| 18 | Pelletizer | No | 2 | 2 | 112 | 0.73 | 4.5 | 1:2.0 | 20 | 68 | 19.0 | 11.7 | no |

S: Samples; A: Processing Equipment Type; B: Steam Injection (yes/no); C: Diameter Die Openings (mm); D: Roller number; E: Roller Speed (rpm); F: Linear Roller Speed (m/s); G: Pitch; H: Pelletizing ratio; I: Temperature material Inlet (° C.); J: Temperature material outlet (° C.); K: Water content material inlet (%); L: Water content material outlet (%); N: Further Cracking (yes/no).

TABLE 4
Roller-mill: settings used to crack selected fines agglomerates

| S | A | B | C | D | E | F | G | H | I | J |
|---|---|---|---|---|---|---|---|---|---|---|
| 7 | Roller- | 6 | Yes | 225 | 5 | 7.5 | 1.0 | Barely crushed | Yes | Yes |
| | Mill | | | | | | | | | |
| 8 | Roller- | 6 | No | 225 | 5 | 7.5 | 0.5 | Highly crushed | No | No |
| | Mill | | | | | | | with fines | | |
| 13 | Roller- | 10 | No | 225 | 5 | 7.5 | 0.5 | Highly crushed | No | No |
| | Mill | | | | | | | with fines | | |
| 14 | Roller- | 11 | No | 225 | 5 | 7.5 | 0.5 | Granulates are too | No | No |
| | Mill | | | | | | | big to be crushed | | |
| 16 | Roller- | 15 | No | 125 | 5 | 7.5 | 3.1 | Coarsely crushed | No | No |
| | Mill | | | | | | | | | |
| 17 | Roller- | 15 | No | 125 | 5 | 7.5 | 0.5 | Highly crushed | No | No |
| | Mill | | | | | | | with fines | | |

S: Samples; A: Processing Equipment type; B: Starting Material (sample number); C: Rollers Diameter (mm); D: Corrugation Per Circumference; E: Linear speed of roller 1 (m/s); F: Linear speed of roller 2 (m/s); G: Gap (mm); H: Description of the cracked material; I: Granulometry Evaluation (Yes/No); J: Extraction evaluation (Yes/No).

TABLE 5
Granulometry of selected samples

| Particle size | | | | | | | | |
|---|---|---|---|---|---|---|---|---|
| category | Sample 7 | | Sample 16 | | Sample 17 | | Fines | |
| (mm) | % | Σ % | % | Σ % | % | Σ % | % | Σ % |
| <0.25 | 2.0 | 2.0 | 0.8 | 0.8 | 4.9 | 4.9 | 37.2 | 37.2 |
| 0.25-0.50 | 2.9 | 4.9 | 1.3 | 2.1 | 8.9 | 13.8 | 23.3 | 60.5 |
| 0.50-0.71 | 2.6 | 7.6 | 1.3 | 3.4 | 7.9 | 21.7 | 22.3 | 82.8 |
| 0.71-1.00 | 4.1 | 11.6 | 2.0 | 5.5 | 14.4 | 36.1 | 17.0 | 99.8 |
| 1.00-1.40 | 6.9 | 18.6 | 2.7 | 8.2 | 24.1 | 60.2 | 0.2 | 100.0 |
| 1.40-2.00 | 14.8 | 33.4 | 5.5 | 13.6 | 37.5 | 97.7 | 0.0 | 100.0 |
| 2.00-2.80 | 38.4 | 71.8 | 8.0 | 21.7 | 2.2 | 99.9 | 0.0 | 100.0 |
| 2.80-3.55 | 23.6 | 95.4 | 10.0 | 31.7 | 0.1 | 100.0 | 0.0 | 100.0 |
| 3.55-4.00 | 3.3 | 98.7 | 8.2 | 39.8 | 0.0 | 100.0 | 0.0 | 100.0 |
| >4.00 | 1.3 | 100.0 | 60.2 | 100.0 | 0.0 | 100.0 | 0.0 | 100.0 |

The produced agglomerates have been characterized for their colour and organoleptic properties and some of them have further been extracted in standard conditions in order to assess their extractability i.e., the ability to extract specifically the soluble sugar fraction contained in the agglomerates and also the solvent percolation through the agglomerates. Finally, the properties of the resulting protein concentrates have been assessed i.e., the protein concentration, their quality i.e., their availability measured by the PDI, their colours and their organoleptic properties. Those results are presented in tables 6. The fines' agglomerates obtained with the process according to the present invention are lighter in colour and have superior organoleptic properties than the fines agglomerates obtained with process known from the prior art for which the fines also originate from soybeans-based white-flakes that have been sieved. Indeed, U.S. Pat. No. 5,097,017 reports fine's agglomerates as the following “The particles are very irregular in shape, and somewhat darker in colour than the starting material with a yellowish hue. The hot particles have a cooked beany odour.”

TABLE 6
Solvent extraction performances and resulting protein concentrate properties of selected
samples (granulates and cracked granulates) and of the reference (sieved white flakes)

| P | U | R1 | R2 | R | S2 | S3 | S5 | S7 | S17 | S18 | M1 | M2 |
|---|---|---|---|---|---|---|---|---|---|---|---|---|
| Percolation | m³/hr/ | 24 | 24 | 24 | >36 | >36 | >36 | >36 | 11 | >36 | >36 | N.A. |
| first wash | m² | | | | | | | | | | | |
| Percolation | m³/hr/ | 19 | 18 | 18.5 | >36 | >36 | >36 | >36 | 7 | >36 | 35 | N.A. |
| final wash | m² | | | | | | | | | | | |
| Extraction | % (w/w) | 25.9 | 24 | 25.0 | 7.5 | 17.1 | 12 | 18 | 19.9 | 16.5 | 23.6 | 23.25 |
| yield | | | | | | | | | | | | |
| Protein | % (w/w) | 70.1 | 69.8 | 70 | 58.6 | 64.6 | 59.9 | 67.1 | 67.9 | 65.1 | 67.7 | 69.3 |
| content (dry | | | | | | | | | | | | |
| matter)(1) | | | | | | | | | | | | |
| PDI of the | Ratio | 75.4 | 77.0 | 76.2 | 34.4 | 18.5 | 45.1 | 52 | 57.7 | 38.6 | N.A. | 70.15 |
| pellets or | Index | | | | | | | | | | | |
| reference | | | | | | | | | | | | |
| Colour of the | Panel | Good | Good | Good | Bad | Bad | Usual | Usual | Usual | Usual | Good | Usual |
| granulates | ranking | | | | | | | | | | | to |
| or cracked | | | | | | | | | | | | Good |
| granulates | | | | | | | | | | | | |
| Organoleptic | Panel | Good | Good | Good | Bad | Bad | Good | Good | Good | Good | Good | Good |
| of the SPC | ranking | | | | | | | | | | | |

P: Properties;
U: Units;
R1: reference first value of the sieved White Flakes (Test 1);
R2: reference second value of the sieved White Flakes (Test 2);
R: reference (average or R1 and R2);
S2: Sample 2 (uncracked extrudates);
S3: Sample3 (uncracked expandates);
S5: Sample 5 (uncracked 3 mm pellets);
S7: Sample 7 (cracked 4 mm pellets);
S17: Sample 17 (cracked expandates);
S18: Sample 18 (uncracked 2 mm pellets);
M1: Mix White Flakes/sample 7 at ratio 75%/25% (w/w) (measured value);
M2: Mix White Flakes/sample 7 at ratio 75%/25% (w/w) (calculated value)

From the results presented in table 6, it is thus clearly apparent that the process according to the present invention is able to deliver fines' granulates substantially preserving the initial quality of the white-flakes' fines. In particular, samples 7 and 17 still possess high PDI (52 and 57.7 respectively) and acceptable protein concentration and good organoleptic properties and colours. Nonetheless, the percolation is low for sample 17. However, it is the percolation of the full fine's agglomerates that has been measured and this situation will not be realised in normal operating condition of a production facility. Indeed, typically those fines' agglomerates are blended in the sieved white-flake in a 25/75 ratio and consequently the percolation of this blend is re-established to an acceptable level. The other quality parameters of this blend are perfectly in line with the expected quality of a food-grade SPC. Such 25/75 ratio blend will typically be used in a SPC production facility.

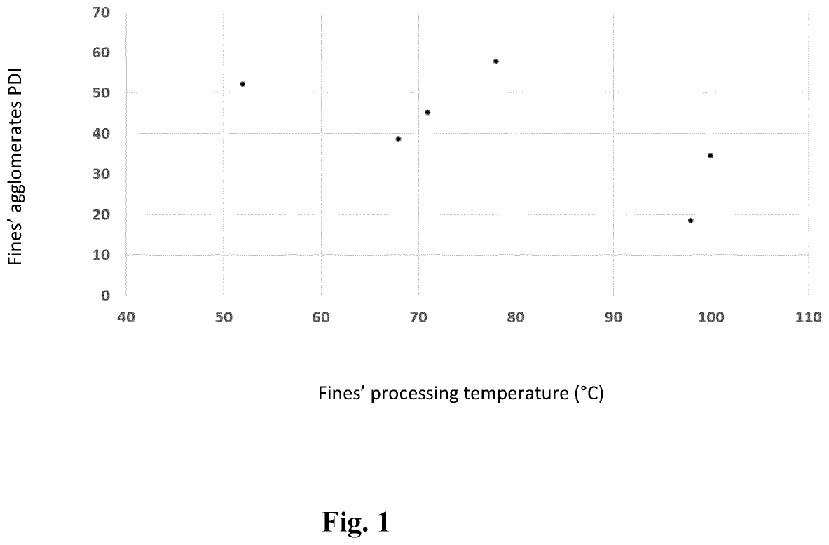

From the results presented in table 6 it is also clearly apparent that the lowest PDI are obtained for fines' granulates samples 2 and 3 (PDI of 34.4 and 18.5 respectively) which have been processed at higher temperature (about 100° C.). Colours and organic properties of Samples 2 and 3 are bad as well as for the SPC derived from those samples. As a matter of fact, even if other parameters such as the water content and the type of processing equipment may have an impact on the PDI, the main parameter is probably the processing temperature of the fines, even if a perfect correlation is not observed as depicted by FIG. 1. Indeed, FIG. 1 plots the PDI values of the fines's granulates vs. their processing temperature. Surprisingly, it seems that below a processing temperature of 80° C., the PDI value of the fines' granulates remains relatively high (between about 40 and 60). On the opposite, above a processing temperature of 80° C. the PDI value of the fine's seems to decrease abruptly.

1. A process for agglomerating fines obtained from sieving of desolventized defatted meal comprising:
moisturizing the fines to produce moisturized fines,
introducing the moisturized fines into a material processing device to produce fines' agglomerates,
wherein the material processing device is equipped with a restriction at its exit, and
wherein the temperature of the processed fines does not exceed 80° C.

2. The process according to claim 1, wherein the desolventized defatted meal is white-flakes.

3. The process according to claim 1, wherein the moisturized fines contain 10% to 20% of water.

4. The process according to claim 1, wherein the material processing device is an extruder, expander and/or pelletizer.

5. The process according to claim 1, wherein the restriction at the exit of the processing device is a die or a cone.

6. The process according to claim 1, wherein the restriction at the exit of processing device is a die or a cone and said die or cone is further equipped with a knife.

7. The process according to claim 1, wherein the fines' agglomerates have a diameter comprised between 1 mm and 10 mm.

8. The process according to claim 1, wherein the fines' agglomerates have a length comprised between 2 mm and 20 mm.

9. The process according to claim 1, wherein the fines' agglomerates are further crushed.

10. The process according to claim 1, wherein the fines' agglomerates are bland in odour and taste.

11. The process according to claim 1, wherein the fines' agglomerates remain light in colour.

12. The process according to claim 1, wherein the PDI of the fines' agglomerates is greater than 38.

13. The process according to claim 2, wherein the moisturized fines contain 10% to 20% of water.

14. The process according to claim 2, wherein the material processing device is an extruder, expander and/or pelletizer.

15. The process according to claim 3, wherein the material processing device is an extruder, expander and/or pelletizer.

16. The process according to claim 2, wherein the restriction at the exit of the processing device is a die or a cone.

17. The process according to claim 3, wherein the restriction at the exit of the processing device is a die or a cone.

18. The process according to claim 4, wherein the restriction at the exit of the processing device is a die or a cone.

19. The process according to claim 2, wherein the restriction at the exit of processing device is a die or a cone and said die or cone is further equipped with a knife.

20. The process according to claim 3, wherein the restriction at the exit of processing device is a die or a cone and said die or cone is further equipped with a knife.
